(19) United States
(12) Patent Application Publication
(10) Pub. No.: US 2009/0213502 A1
(43) Pub. Date: Aug. 27, 2009

(54) MAGNETO-RESISTANCE EFFECT ELEMENT HAVING STACK WITH DUAL FREE LAYER AND A PLURALITY OF BIAS MAGNETIC LAYERS

(76) Inventors: Daisuke MIYAUCHI, Tokyo (JP); Koji SHIMAZAWA, Tokyo (JP); Tsutomu CHOU, Tokyo (JP); Takahiko MACHITA, I, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 12/036,530

(22) Filed: Feb. 25, 2008

(51) Int. Cl. G11B 5/33; G11B 5/84

(52) U.S. Cl. 360/319; 427/131

(57) ABSTRACT

A magneto-resistance effect element comprises: a magneto-resistance effect stack including an upper magnetic layer and a lower magnetic layer whose magnetization directions change in accordance with an external magnetic field, a non-magnetic intermediate layer sandwiched between the upper and lower magnetic layers; an upper shield electrode layer and a lower shield electrode layer which are provided to sandwich the magneto-resistance effect stack therebetween in the direction of stacking the magneto-resistance effect stack, wherein the upper shield electrode layer and the lower shield electrode layer supply sense current in the direction of stacking, and magnetically shield the magneto-resistance effect stack; a first bias magnetic layer which is provided on a surface of the magneto-resistance effect stack opposite to an air bearing surface, and wherein the first bias magnetic layer is magnetized in a direction perpendicular to said air bearing surface; and a pair of second bias magnetic layers provided on respective both sides of said magneto-resistance effect stack in a track width direction, and wherein the second bias magnetic layers are magnetized in a direction substantially parallel to said track width direction; wherein the magnetic pole on a surface of one of said second bias magnetic layers which faces said magneto-resistance effect stack has the same polarity as the magnetic pole on a surface of the other of said second bias magnetic layers which faces said magneto-resistance effect stack, and has a polarity different from the polarity of the magnetic pole on a surface of said first bias magnetic layer which faces said magneto-resistance effect stack.

### BACKGROUND OF THE INVENTION

1. Field of the Invention

The present invention relates to a magneto-resistance effect element and a method of manufacturing same, and more particularly to the element structure of a magneto-resistance effect element having dual free layers.

2. Description of the Related Art

Thin-film magnetic heads used in hard disk drives are constructed from a readout head having a reproducing element for reading and a write head having an inductive-type electromagnetic conversion device for writing. A giant magneto-resistance (GMR) element is known as the reproducing element of the thin film magnetic head. Conventionally, CIP (Current In Plane) GMR elements in which a sense current flows in a direction parallel to the film surface have been mainly used. Recently, however, in order to support ever higher recording densities, CPP (Current Perpendicular to the Plane) type elements in which the sense current flows in a direction perpendicular to the film surface have been developed. Known examples of this type of element include TMR (Tunnel Magneto-resistance) elements utilizing TMR effects and CPP-GMR elements utilizing GMR effects.

CPP elements include a magneto-resistance effect (MR) stack having a magnetic layer (free layer) in which the magnetization direction changes according to an external magnetic field, a magnetic layer (pinned layer) in which the magnetization direction is fixed, and a non-magnetic intermediate layer which is sandwiched between the pinned layer and the free layer. To fix the magnetization direction in the pinned layer, the MR stack is provided with an anti-ferromagnetic layer (pinning layer). The pinning layer is provided adjacent to the pinned layer, and fix the magnetization direction of the pinned layer by exchange coupling with the pinned layer. The MR stack may also be called a spin valve film.

Bias magnetic layers for applying a bias magnetic field to the free layer are provided on both sides of the spin-valve film in a track width direction. The bias magnetic layers apply a bias magnetic-field to the free layer in a direction parallel to the track width direction. In an Initial magnetization state (the state in which only a bias magnetic field is applied), the free layer is magnetized in a direction perpendicular to the magnetization direction of the pinned layer. The free layer is turned into a single magnetic domain by the bias magnetic field emitted from the bias magnetic layers. This provides an improvement in linearity of a change in resistance with respect to a change in an external magnetic field and an effective reduction in Barkhausen noise. A relative angle between the magnetization direction of the free layer and the magnetization direction of the pinned layer changes in accordance with an external magnetic field, and as a result, electric resistance of sense current that flows in a direction perpendicular to the film surface of the spin-valve film is changed. The external magnetic field is detected based on the above property. The spin-valve film is magnetically shielded by shield layers on both sides thereof with regard to the direction of stacking. The stacked direction of the spin-valve film is aligned with the circumferential direction of the recording medium when a thin-film magnetic head is assembled in the hard disk drive. Therefore, the shield layers have a role of shielding a magnetic field emitted from adjacent bits on the same track of the recording medium.

In recent years, higher recording density is desired. However, an improvement in recording density requires an improvement in track recording density, which requires a reduction in spacing between upper and lower shield layers (a gap between shields). In order to achieve this, a decrease in thickness of the spin-valve film is required. However, there is large limitation that originates from the layer structure in the conventional CPP elements. Specifically, since the pinned layer requires that the magnetization direction be firmly fixed without being influenced by an external magnetic field, a so-called synthetic pinned layer is usually used. The synthetic pinned layer includes an outer pinned layer, an inner pinned layer, and a non-magnetic intermediate layer which consists of Ru or Rh and which is sandwiched between the outer pinned layer and the inner pinned layer. Moreover, an antiferromagnetic layer is provided in contact with the outer pinned layer in order to fix the magnetization direction of the outer pinned layer. The antiferromagnetic layer typically consists of IrMn. In the synthetic pinned layer, the antiferromagnetic layer is coupled to the outer pinned layer via exchange-coupling so that the magnetization direction of the outer pinned layer is fixed. The inner pinned layer is antiferromagnetically coupled to the outer pinned layer via the non-magnetic intermediate layer so that the magnetization direction of the inner pinned layer is fixed. Since the magnetization directions of the inner pinned layer and the outer pinned layer are anti-parallel to each other, magnetization of the pinned layer is limited as a whole. Despite such a merit of the synthetic pinned layer, however, a large number of layers are required to constitute a CPP element that includes the synthetic pinned layer. This imposes limitation on a reduction in the thickness of the spin-valve film.

Meanwhile, a novel layer structure that is entirely different from that of the above-mentioned conventional spin-valve film has been proposed in recent years. Specifically, “Current-in-Plane GMR Tri-layer Head Design for Hard-Disk Drives” (IEEE TRANSACTIONS ON MAGNETICS, Vol. 43, No. 2, February 2007) discloses, for a CIP element, an MR stack that includes a upper and lower magnetic layers in which the magnetization directions change according to the external magnetic field, and a non-magnetic intermediate layer sandwiched between the upper magnetic layer and the lower magnetic layer. Since the magnetization directions of the upper and lower magnetic layers change according to the external magnetic field, these layers may also be called free layers. A bias magnetic layer is provided on a side of the MR stack opposite to an air bearing surface, and a bias magnetic field is applied in a direction that is perpendicular to the air bearing surface. The magnetization directions of the upper and lower magnetic layers adopt a certain relative angle because of the magnetic field applied from the bias magnetic layer. If an external magnetic field is applied in this state, then the magnetization directions of the upper and lower magnetic layers are changed. As a result, the relative angle between the magnetization direction of the upper magnetic layer and the magnetization direction of the lower magnetic layer is changed, and accordingly, electric resistance of sense current is changed. It is possible to detect the external magnetization based on this property. U.S. Pat. No. 7,035,062 discloses an example in which such a layer structure is applied to a CPP element. Such a layer structure using the pair of free layers has a potential for facilitating a reduction in gap between the shields, because it does not require the conventional synthetic pinned layer and the antiferromagnetic layer, allowing a simplified layer structure.

However, the magneto-resistance effect (MR) element with the pair of free layers has the following problems: As the film thickness of the MR stack is reduced, the film thickness of the bias magnetic layer is also reduced. Unlike the configuration according to the related art, the bias magnetic layer is provided only on the side of the MR stack which is opposite to the air bearing surface. Accordingly, the bias magnetic field emitted from the bias magnetic layer is liable to be dispersed, and cannot efficiently be applied to the upper and lower magnetic layers as the free layers. For these reasons, it is difficult for the bias magnetic field to maintain a magnetic field intensity level strong enough to turn the upper and lower magnetic layers into a single magnetic domain.

### SUMMARY OF THE INVENTION

The present invention is directed to a CPP type magneto-resistance effect element of a layer structure including a magneto-resistance effect stack having a pair of free layers, and provided with bias magnetic layers. It is an object of the present invention to provide a magneto-resistance effect element with the above layer structure which will have a reduced gap between the shields for higher recording density and which will produce an increased bias magnetic field for increased magnetic field detection sensitivity. Another object of the present invention is to provide a method of manufacturing such a magneto-resistance effect element.

According to an embodiment of the present invention, a magneto-resistance effect element comprising: a magneto-resistance effect stack including an upper magnetic layer and a lower magnetic layer whose magnetization directions change in accordance with an external magnetic field, a non-magnetic intermediate layer sandwiched between the upper and lower magnetic layers; an upper shield electrode layer and a lower shield electrode layer which are provided to sandwich the magneto-resistance effect stack therebetween in the direction of stacking the magneto-resistance effect stack, wherein the upper shield electrode layer and the lower shield electrode layer supply sense current in the direction of stacking, and magnetically shield the magneto-resistance effect stack; a first bias magnetic layer which is provided on a surface of the magneto-resistance effect stack opposite to an air bearing surface, and wherein the first bias magnetic layer is magnetized in a direction perpendicular to said air bearing surface; and a pair of second bias magnetic layers provided on respective both sides of said magneto-resistance effect stack in a track width direction, and wherein the second bias magnetic layers are magnetized in a direction substantially parallel to said track width direction; wherein the magnetic pole on a surface of one of said second bias magnetic layers which faces said magneto-resistance effect stack has the same polarity as the magnetic pole on a surface of the other of said second bias magnetic layers which faces said magneto-resistance effect stack, and has a polarity different from the polarity of the magnetic pole on a surface of said first bias magnetic layer which faces said magneto-resistance effect stack.

In accordance with this structure, the need for providing a pinning layer and a synthetic pinned layer in the magneto-resistance stack is obviated, and a reduction in the magneto-resistance stack thickness is facilitated. Therefore, a reduction in the gap between the shields can be achieved. Since second bias magnetic layers are formed on both sides of the magneto-resistance stack, a strong bias magnetic field is applied to the upper and lower magnetic layers as free layers. Thus, the magnetization direction of the upper magnetic layer and the magnetization direction of the lower magnetic layer are substantially perpendicular to each other. In this way, it is possible to increase the detection sensitivity of the magneto-resistance effect element and to provide a magneto-resistance effect element that can easily cope with high recording density.

According to another embodiment of the present invention, a method of manufacturing a magneto-resistance effect element, comprising: a magneto-resistance effect stack forming step of forming a lower magnetic layer whose magnetization direction changes in accordance with an external magnetic field, a non-magnetic intermediate layer, and an upper magnetic layer whose magnetization direction changes in accordance with an external magnetic field, successively upwardly in the order named in a direction of stacking, on a lower shield electrode layer; a second bias magnetic layer forming step of removing both sides of said magneto-resistance effect stack in a track width direction, and filling removed spaces with a pair of second bias magnetic layers respectively therein; a first bias magnetic layer forming step of forming a recess in a surface opposite to a surface to be formed into an air bearing surface of said magneto-resistance effect stack, wherein said recess extends toward said magneto-resistance effect stack while a width thereof in the track width direction decreases, and filling a portion of said recess with a first bias magnetic layer; a magnetization direction securing step of securing magnetization directions of said second bias magnetic layers substantially parallel to said track width direction, such that the magnetic pole on a surface of one of said second bias magnetic layers which faces said magneto-resistance effect stack has the same polarity as the magnetic pole on a surface of the other of said second bias magnetic layers which faces said magneto-resistance effect stack, and has a polarity different from the polarity of the magnetic pole on a surface of said first bias magnetic layer which faces said magneto-resistance effect stack; and an upper shield electrode layer forming step of forming an upper shield electrode layer on said magneto-resistance effect stack, said first bias magnetic layer, and said second bias magnetic layers.

The above and other objects, features and advantages of the present invention will become apparent from the following description with reference to the accompanying drawings which illustrate examples of the present invention.

### BRIEF DESCRIPTION OF THE DRAWINGS

FIG. 1 is a perspective view of a magneto-resistance effect element according to an embodiment of the present invention;

FIG. 2A is a side view of the magneto-resistance effect element when viewed from 2A-2A direction of FIG. 1;

FIG. 2B is a cross-sectional view of the magneto-resistance effect element along 2B-2B line of FIG. 1;

FIG. 2C is a cross-sectional view along 2C-2C line of FIG. 2A;

FIG. 3 is a view showing the directions of bias magnetic fields applied from first and second bias magnetic layers;

FIG. 4 is a conceptual view showing an operation principle of the magneto-resistance effect element shown in FIG. 1;

FIG. 5A is a diagram showing the magnetization direction of an upper magnetic layer in the absence of a bias magnetic field;

FIG. 5B is a diagram showing the magnetization direction of a lower magnetic layer in the absence of a bias magnetic field;

FIG. 6A is a diagram showing the magnetization direction of the upper magnetic layer when only the bias magnetic field from the first bias magnetic layer is applied;

FIG. 6B is a diagram showing the magnetization direction of the lower magnetic layer when only the bias magnetic field from the first bias magnetic layer is applied;

FIG. 7A is a diagram showing the magnetization direction of the upper magnetic layer when the bias magnetic fields from the first and second bias magnetic layers are applied;

FIG. 7B is a diagram showing the magnetization direction of the lower magnetic layer when the bias magnetic fields from the first and second bias magnetic layers are applied;

FIG. 8 is a flowchart explaining a method of manufacturing the magneto-resistance effect element shown in FIG. 1;

FIGS. 9A to 17C are step diagrams explaining the method of manufacturing the magneto-resistance effect element shown in FIG. 1;

FIG. 18 is a graph showing the relationship between the width of a tip end of the first bias magnetic layer and the output of the magneto-resistance effect element;

FIG. 19 is a graph showing the relationship between the angle of the tip end of the first bias magnetic layer and the output of the magneto-resistance effect element;

FIGS. 20A and 20B are cross-sectional views of magneto-resistance effect elements including first bias magnetic layer having different tip end angle;

FIG. 21 is a cross-sectional view of a thin-film magnetic head taken along a plane perpendicular to air bearing surface S;

FIG. 22 is a plan view of a wafer which is used to manufacture the magneto-resistance effect element of the present invention;

FIG. 23 is a perspective view of a slider of the present invention;

FIG. 24 is a perspective view of a head arm assembly including a head gimbal assembly which incorporates a slider of the present invention;

FIG. 25 is a side view of a head arm assembly which incorporates sliders of the present invention; and

FIG. 26 is a plan view of a hard disk drive which incorporates sliders of the present invention.

### DESCRIPTION OF THE PREFERRED EMBODIMENTS

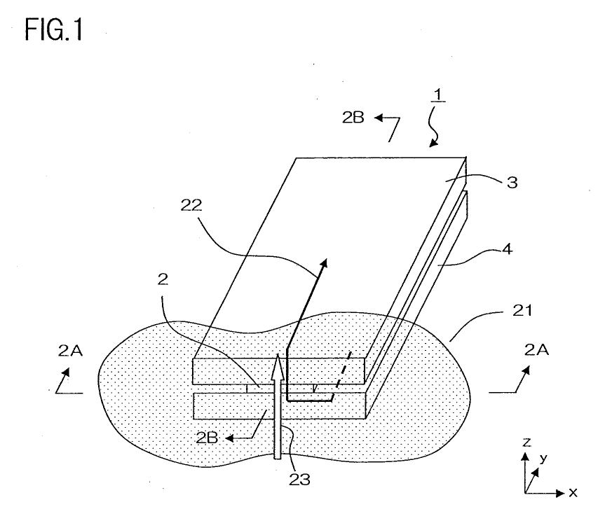

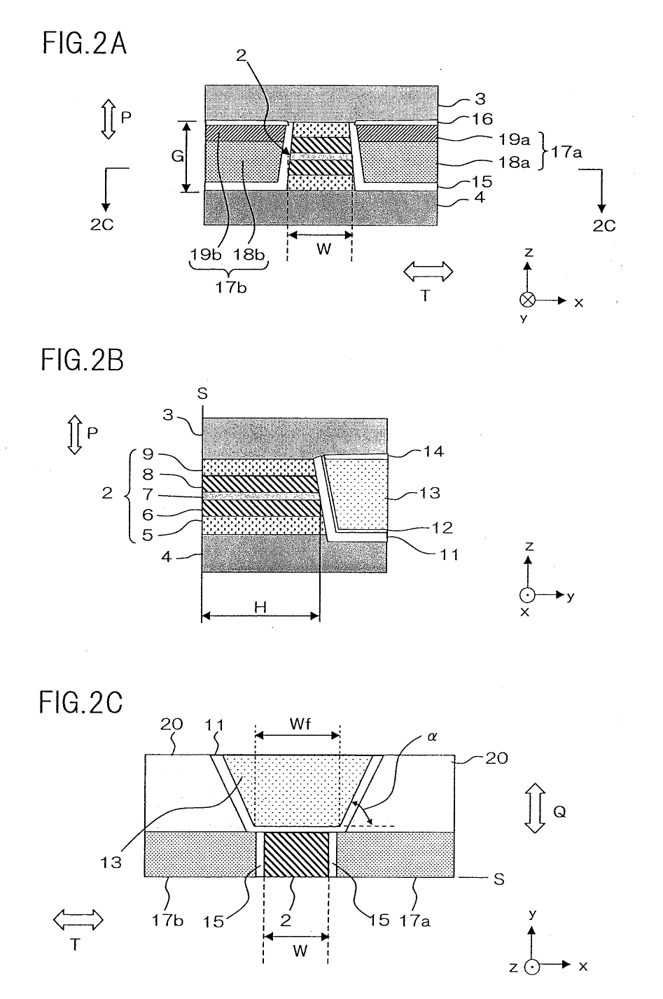

An embodiment of the present invention will now be described with reference to the attached drawings. A magneto-resistance effect element of the present embodiment is particularly suitable for use as the reading device of a thin-film magnetic head in a hard-disk drive. FIG. 1 is a perspective view of the magneto-resistance effect element according to the embodiment of the present invention. FIG. 2A is a side view of the magneto-resistance effect element when viewed from 2A-2A direction of FIG. 1, i.e., viewed from an air bearing surface (a surface parallel to a z-x plane in FIG. 1). FIG. 2B is a cross-sectional view of the magneto-resistance effect element as viewed from a surface along 2B-2B line of FIG. 1, i.e., a surface perpendicular to a track width direction T (a surface parallel to a y-z plane in FIG. 1). FIG. 2C is a cross-sectional view of the magneto-resistance effect element as viewed from a surface along 2C-2C line of FIG. 2A, i.e., a surface along a film surface of a magneto-resistance effect (MR) stack (a surface parallel to an x-y plane in FIG. 1), or specifically as viewed from above in direction of stacking P of the MR stack. The air bearing surface (ABS) refers to a surface of magneto-resistance effect element 1 which faces recording medium 21.

Magneto-resistance effect element 1 comprises MR stack 2, upper shield electrode layer 3 and lower shield electrode layer 4 which are provided such that they sandwich MR stack 2 in the direction of stacking P, first bias magnetic layer 13 provided on the surface of stack 2 that is opposite to air bearing surface S, and a pair of second bias magnetic layers 17a, 17b provided respectively on both sides of MR stack 2 in track width direction T.

MR stack 2 is sandwiched between upper shield electrode layer 3 and lower shield electrode layer 4 with the tip end thereof exposed at air bearing surface S. When a voltage is applied between upper shield electrode layer 3 and lower shield electrode layer 4, sense current 22 flows through MR stack 2 in direction of stacking P, i.e., a direction perpendicular to the film surfaces. Magnetic field of recording medium 21 at a position facing MR stack 2 changes in accordance with the movement of recording medium 21 in moving direction 23 The change in magnetic field is detected as a change in electric resistance which is caused by the magneto-resistance effect. Based on this principle, magneto-resistance effect element 1 reads magnetic information that is recorded in each magnetic domain of recording medium 21.

Table 1 shows an example of the layer structure of MR stack 2. In the table, the layers are shown in the order of stacking, from buffer layer 5 in the bottom column, which is on the side of lower shield electrode layer 4, toward cap layer 9 in the top column, which is on the side of upper shield electrode layer 3. In Table 1, the numerical values in the composition column represent atomic percentage of the elements. MR stack 2 includes buffer layer 5, lower magnetic layer 6, non-magnetic intermediate layer 7, upper magnetic layer 8, and cap layer 9, which are successively stacked in the order named on lower shield electrode layer 4 which is made of an 80Ni20Fe layer having a thickness of about 1 μm.

TABLE 1

| Layer Structure | Composition | Thickness (nm) |
|---|---|---|
| Cap Layer 9 | Ta | 2.0 |
| | Ru | 10.0 |
| Upper Magnetic Layer 8 | 70Co30Fe | 1.0 |
| | 80Ni20Fe | 2.5 |
| | 70Co30Fe | 1.0 |
| Non-Magnetic | Cu | 1.3 |
| Intermediate Layer 7 | | |
| Lower Magnetic Layer 6 | 70Co30Fe | 1.0 |
| | 80Ni20Fe | 2.5 |
| | 70Co30Fe | 1.0 |
| Buffer Layer 5 | 55Ni45Cr | 8.0 |
| | Ta | 1.0 |
| | (Total) | 31.3 |

Buffer layer 5 is provided as a seed layer for lower magnetic layer 6. Both lower magnetic layer 6 and upper magnetic layer 8, which have layer configurations in which a NiFe layer is sandwiched by CoFe layers, are free layers whose magnetization directions are changed in accordance with an external magnetic field. A Cu layer is provided as non-magnetic intermediate layer 7 between the pair of free layers. The Cu layer has a film thickness of 1.3 nm. Cu exhibits the largest binding energy at this thickness, allowing lower magnetic layer 6 and upper magnetic layer 8 to be magnetically strongly coupled via antiferromagnetic coupling.

By providing the CoFe layers in lower magnetic layer 6 and in upper magnetic layer 8, the spin polarization factor is increased at the interfaces of the Cu layer as compared to the layer configuration in which the Cu layer and the NiFe layer is in direct contact, and thus the magnetic resistance effect is enhanced. Non-magnetic intermediate layer 7 may comprise a Ru layer instead of the Cu layer.

Either one or both of lower magnetic layer 6 and upper magnetic layer 8 may comprise a single 70Co30Fe layer rather than the multi-layer configuration shown in Table 1. Cap layer 9 is provided to prevent deterioration of each layer. Upper shield electrode layer 3, which is made of an 80Ni20Fe layer having a thickness of about 1 μm, is provided on cap layer 9.

Upper shield electrode layer 3 and lower shield electrode layer 4 function as electrodes for supplying sense current 22 to MR stack 2 in direction of stacking P (the direction perpendicular to the film surfaces), and also function as shield layers for shielding against magnetic field emitted from adjacent bits on the same track of recording medium 21. Specifically, since direction of stacking P of MR stack 2 corresponds to the circumferential direction of recording medium 21 when the thin film magnetic head is incorporated into a hard disc drive, a magnetic field emitted from adjacent bits on the same track of recording medium 21 is shielded by upper shield layer 3 and lower shield layer 4.

When magneto-resistance effect element 1 is viewed from recording medium 21, as shown in FIG. 2A, MR stack 2 is surrounded by upper shield electrode layer 3 and lower shield electrode layer 4. Thus, upper shield electrode layer 3 and lower shield electrode layer 4 define gap G between the shields of magneto-resistance effect element 1. Gap G between the shields is determined by the film thickness of MR stack 2. In the magneto-resistance effect element 1 of the present embodiment, since the pinning layer and the outer pinned layer become unnecessary, a significant reduction in thickness can be achieved as compared to the spin-valve film of the conventional CPP element. Therefore, Gap G between the shields is highly reduced.

First bias magnetic layer 13 is provided such that it faces the surface of MR stack 2 that is opposite to air bearing surface S. First bias magnetic layer 13 may be made of a CoPt layer having a thickness of 30 nm, for example. First bias magnetic layer 13 should preferably be made of a hard magnetic material such as CoPt. First bias magnetic layer 13 is provided on seed layer 12 in order to ensure good magnetic characteristics (high coercive force and squareness ratio). Seed layer 12 may be made of a Cr layer having a thickness of 3 nm, for example.

Insulating film 11 made of Al₂O₃ is provided between seed layer 12 and MR stack 2. As shown in FIG. 2B, insulating film 11 extends over the side of MR stack 2 which faces first bias magnetic layer 13 for thereby preventing sense current 22 from flowing into first bias magnetic layer 13.

Cap layer 14 made of Al₂O₃ is provided on first bias magnetic layer 13 for preventing sense current 22 from flowing into first bias magnetic layer 13. A Cr layer may be provided between cap layer 14 and first bias magnetic layer 13 for allowing first bias magnetic layer 13 to have good magnetic characteristics. Cap layer 14 may be made of a non-magnetic metal layer.

On both sides of MR track 2 in track width direction T, second bias magnetic layers 17a, 17b are provided via insulating films 15 that consist of Al₂O₃. Second bias magnetic layers 17a, 17b comprise respective ferromagnetic layers 18a, 18b and respective antiferromagnetic layers 19a, 19b. Table 2 shows an example of the layer structure of second bias magnetic layers 17a, 17b.

TABLE 2

| | Layer Structure | Composition | Thickness (nm) |
|---|---|---|---|
| Second Bias | Antiferromagnetic | IrMn | 7.0 |
| Magnetic Layers | Layers 19a, 19b | | |
| 17a, 17b | Ferromagnetic Layers | NiFe | 20.0 |
| | 18a, 18b | | |

Ferromagnetic layers 18a, 18b comprise respective soft magnetic layers each made of 80Ni20Fe. Antiferromagnetic layers 19a, 19b comprise respective IrMn layers, and are strongly exchange-coupled antiferromagnetically to ferromagnetic layers 18a, 18b. Therefore, ferromagnetic layers 18a, 18b have their magnetization directions secured substantially parallel to track width direction T. The magnetization direction of ferromagnetic layer 18a is substantially anti-parallel to the magnetization direction of ferromagnetic layer 18b. In other words, the magnetic pole on the surface of second bias magnetic layer 17a which faces MR stack 2 has the same polarity as the magnetic pole on a surface of the second bias magnetic layer 17b which faces the MR stack 2.

Antiferromagnetic layers 19a, 19b may comprise PtMn layers, NiMn layers, or the like rather than the IrMn layers. Ferromagnetic layers 18a, 18b may comprise arbitrary soft magnetic layers which can strongly be exchange-coupled to antiferromagnetic layers 19a, 19b, rather than the NiFe layers.

Cap layers 16, which are made of Al₂O₃ and have a thickness of about 5 nm, are provided respectively on second bias magnetic layers 17a, 17b. Insulating films 15 and cap layers 16 serve to prevent sense current 22 from flowing into bias magnetic layers 17a, 17b.

As shown in FIG. 2C, first bias magnetic layer 13 extends toward MR stack 2 while a width thereof in track width direction T decreases. Specifically, first bias magnetic layer 13 is in the shape of an isosceles trapezoid within a plane parallel to the stacked layers, the isosceles trapezoid having two sides parallel with the shorter side being disposed closely to MR stack 2. The width of the shorter side (hereinafter referred to as tip end width Wf is about the same as the width of MR stack 2 in track width direction T. Therefore, the magnetic fluxes in first bias magnetic layer 13 are gradually converged in the isosceles trapezoid thereof, and are efficiently applied to MR stack 2.

The exterior angle α (hereinafter referred to as tip end angle α) at both ends of the shorter side of the isosceles trapezoid is of about 60 degrees (see FIG. 2C), for example.

Non-magnetic layers 20 are provided on the both sides of first bias magnetic layer 13 in track width direction T. Non-magnetic layers 20 are made of respective Cr layers, for example, and are provided to keep first bias magnetic layer 13 and second bias magnetic layers 17a, 17b spaced from each other. In other words, second bias magnetic layers 17a, 17b are not disposed on both sides of first bias magnetic layer 13 in track width direction T.

Insulating layers made of Al₂O₃ are provided between non-magnetic layers 20 and lower shield electrode layer 4. Cap layers of Al₂O₃ are provided between non-magnetic layers 20 and upper shield electrode layer 3. These insulating layers and cap layers serve to prevent sense current 22 from flowing into non-magnetic layers 20.

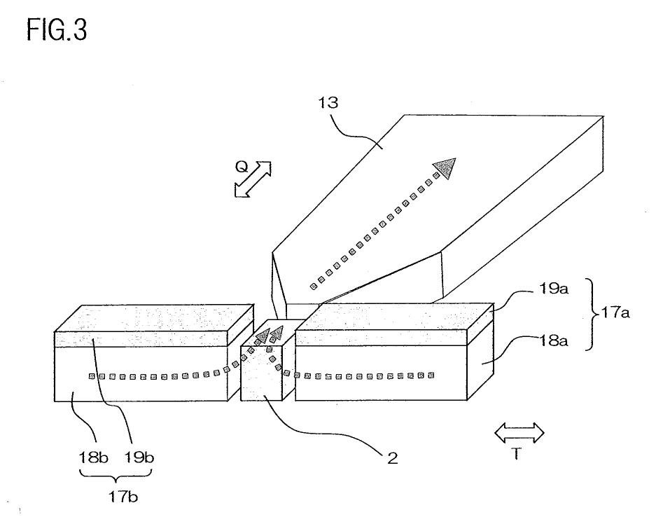

The magnetic pole on the surface of first bias magnetic layer 13 which faces MR stack 2 has a polarity different from the polarity of the magnetic pole on surfaces of the second bias magnetic layers 17a, 17b which face MR stack 2. FIG. 3 shows the directions of bias magnetic fields from first and second bias magnetic layers 13, 17a, 17b. In FIG. 3, MR stack 2 and first and second bias magnetic layers 13, 17a, 17b are schematically illustrated, and the arrows represent the directions of the bias magnetic fields. In second bias magnetic layers 17a, 17b, the magnetic fields extend toward MR stack 2. In MR stack 2, the magnetic fields extend toward first bias magnetic layer 3, i.e., in a direction substantially perpendicular to air bearing surface S. In first bias magnetic layer 13, the magnetic field extends in direction Q perpendicular to air bearing surface S. Accordingly, a strong bias magnetic field which is substantially perpendicular to air bearing surface S is applied to MR stack 2.

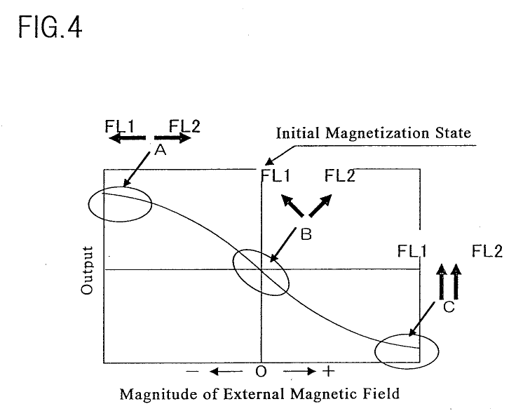

FIG. 4 is a conceptual view showing the operation principle of the magneto-resistance effect element of the present embodiment. The abscissa indicates magnitude of external magnetic field, and the ordinate indicates signal output. In the figure, the magnetization direction of upper magnetic layer 8 and the magnetization direction of lower magnetic layer 6 are indicated by FL1 and FL2, respectively. When neither bias magnetic fields emitted from first and second bias magnetic layer 13, 17a, 17b nor an external magnetic field emitted from recording medium 21 does not exist, the magnetization direction of upper magnetic layer 8 and the magnetization direction of lower magnetic layer 6 are anti-parallel to each other. However, since a bias magnetic field is applied actually, the magnetization direction of upper magnetic layer 8 and the magnetization direction of lower magnetic layer 6 are rotated from the anti-parallel state toward a parallel state. Thus, the relative angle formed between the magnetization direction of upper magnetic layer 8 and the magnetization direction of lower magnetic layer 6 is about 90° at an initial magnetization state (B in the figure). When an external magnetic field is applied from recording medium 21 in this state, the relative angle between the magnetization direction of upper magnetic layer 8 and the magnetization direction of lower magnetic layer 6 increases (a state closer to the anti-parallel state) or decreases (a state closer to the parallel state) in accordance with the direction of the external magnetic field. If the state comes close to the anti-parallel state, then electrons emitted from the electrode are apt to be scattered, leading to an increase in electric resistance of sense current 22 (see A in the figure). If the state comes close to the parallel state, then electrons emitted from electrode are less apt to be scattered, leading to a decrease in the electric resistance of sense current 22 (see C in the figure). In this way, by utilizing the change in the relative angle between the magnetization direction of upper magnetic layer 8 and the magnetization direction of lower magnetic layer 6, an external magnetic field can be detected.

In the present embodiment, as a result of adjusting the thickness, the configuration, etc. of first and second bias magnetic layers 13, 17a, 17b, the magnetization direction of upper magnetic layer 8 and the magnetization direction of lower magnetic layer 6 are approximately perpendicular to each other in the initial magnetization state (B in FIG. 4). Because the magnetization directions are perpendicular to each other in the initial magnetization state, a large change in output against a change in an external magnetic field, and thus, a large change in magnetic resistance can be obtained, and good asymmetry can also be obtained. If the bias magnetic field is insufficient, then the initial magnetization state becomes close to the anti-parallel state (A in FIG. 4), leading to low output and large asymmetry. Similarly, if the bias magnetic field is excessive, then the initial magnetization state becomes close to the parallel state (C in FIG. 4), leading to low output and large asymmetry.

Magneto-resistance effect element 1 of the present embodiment include not only first bias magnetic layer 13, but also second bias magnetic layers 17a, 17b for applying bias magnetic field of sufficient magnitude to upper and lower magnetic layers 8, 6.

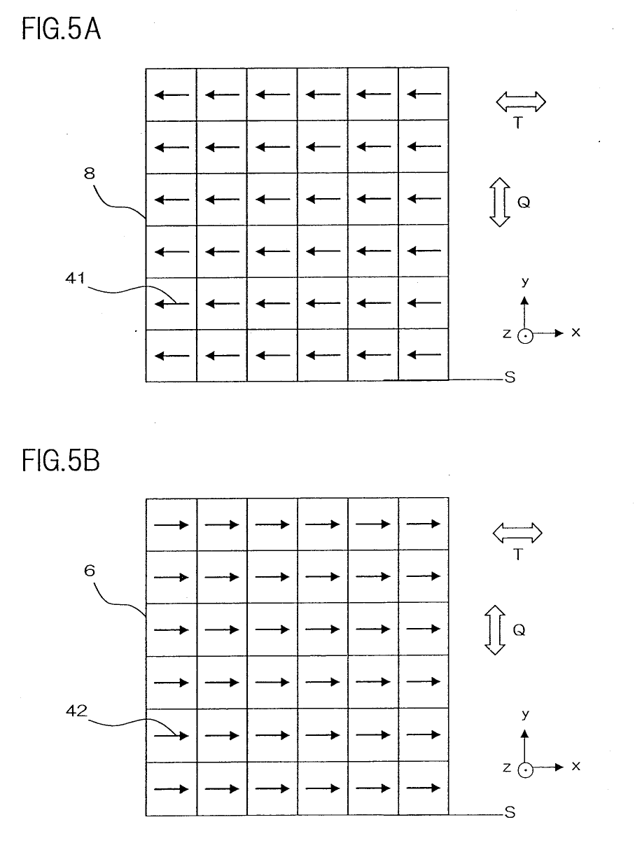

The magnetization directions of upper and lower magnetic layers 8, 6 will be described in detail below. FIG. 5A schematically shows the magnetization direction of upper magnetic layer 8 in the absence of a bias magnetic field, and FIG. 5B schematically shows the magnetization direction of lower magnetic layer 6 in the absence of a bias magnetic field. With no bias magnetic field being applied, magnetization direction 41 of upper magnetic layer 8 extends parallel to track width direction T. Since the magnetization of lower magnetic layer 6 is antiferromagnetically coupled to the magnetization of upper magnetic layer 8, magnetization direction 42 of lower magnetic layer 6 extends anti-parallel to magnetization direction 41 of upper magnetic layer 8.

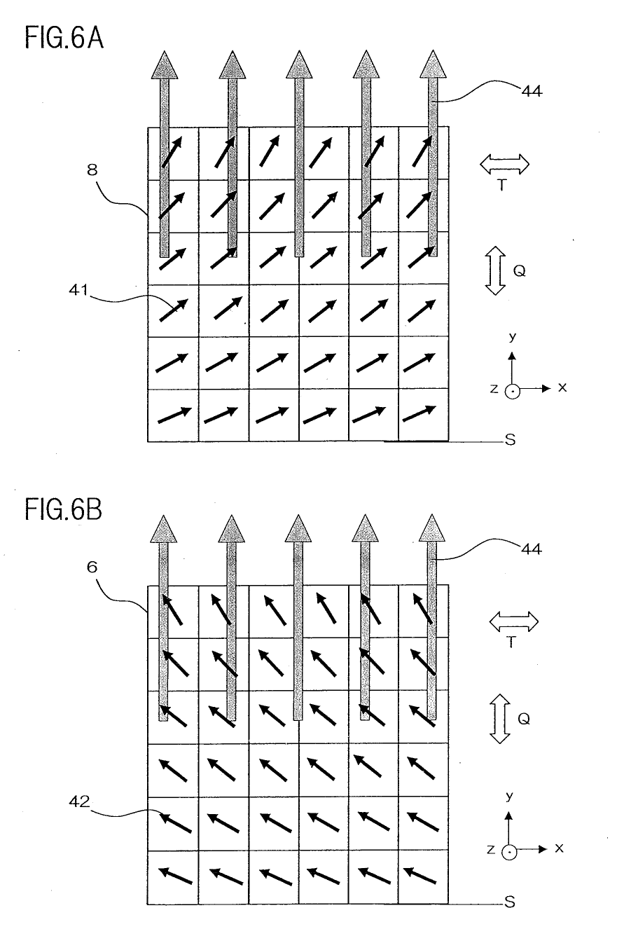

FIGS. 6A and 6B show the magnetization directions of upper and lower magnetic layers 8, 6 of a magneto-resistance effect element which has not second bias magnetic layers 17a, 17b. Specifically, FIG. 6A shows the magnetization direction of upper magnetic layer 8 when only the bias magnetic field emitted from first bias magnetic layer 13 is applied, and FIG. 6B shows the magnetization direction of lower magnetic layer 6 when only the bias magnetic field emitted from first bias magnetic layer 13 is applied. Bias magnetic field 44 is applied in direction Q perpendicular to air bearing surface S. Therefore, magnetization directions 41, 42 of upper magnetic layer 8 and lower magnetic layer 6 are rotated from track width direction T. Magnetization directions 41, 42 of upper magnetic layer 8 and lower magnetic layer 6 are substantially perpendicular to each other. Since first bias magnetic layer 13 is provided on a side of the MR stack 2 opposite to air bearing surface S, the intensity of bias magnetic field 44 at air bearing surface S is relatively low. Therefore, it is difficult for the magnetization directions of upper and lower magnetic layers 8, 6 to extend perpendicularly to each other in a region near air bearing surface S. Particularly, because upper and lower magnetic layers 8, 6 that are near air bearing surface S tend to react sharply to the external magnetic field emitted from recording medium 21, it is necessary to maintain a necessary bias magnetic field near air bearing surface S.

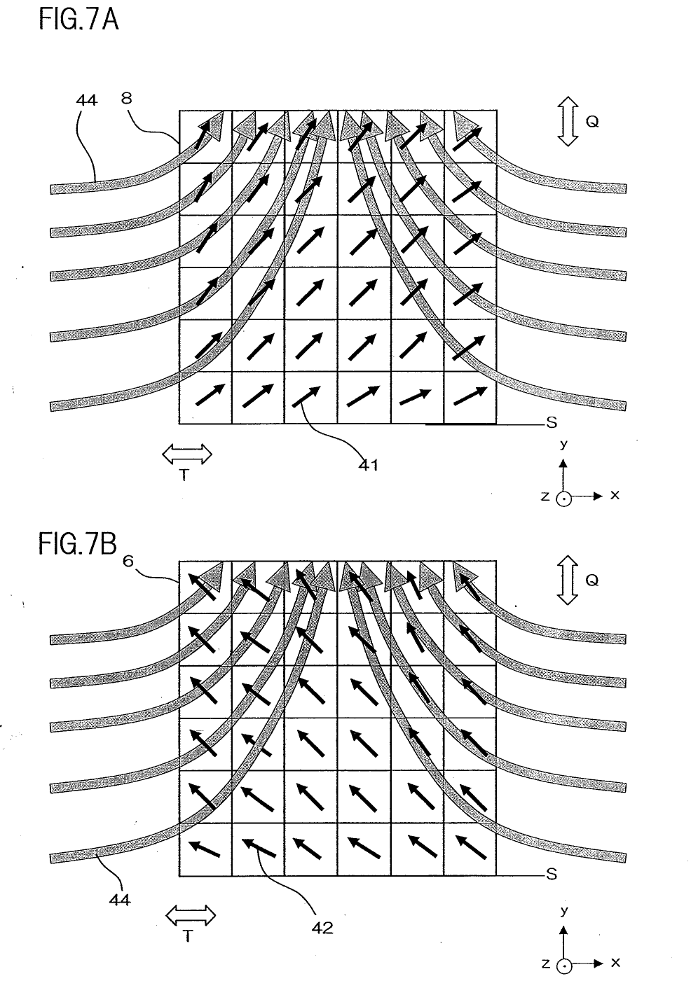

FIG. 7A shows the magnetization direction of upper magnetic layer 8 when the bias magnetic fields emitted from first and second bias magnetic layers 13, 17a, 17b are applied, and FIG. 7B shows the magnetization direction of lower magnetic layer 6 when the bias magnetic fields emitted from first and second bias magnetic layers 13, 17a, 17b are applied. According to the present embodiment, since second bias magnetic layers 17a, 17b are provided respectively on both sides of MR stack 2 in track width direction T, strong bias magnetic field 44 is applied to wider areas of upper and lower magnetic layers 8, 6 than in the case of the magnetization directions shown in FIGS. 6A and 6B. Particularly, the intensity of bias magnetic field 44 near air bearing surface S is increased. Near the centers of upper and lower magnetic layers 8, 6, bias magnetic field 44 has its direction Q substantially perpendicular to air bearing surface S. As a result, the magnetization directions of upper and lower magnetic layers 8, 6 are substantially perpendicular to each other in wider areas than in the case of the magnetization directions shown in FIGS. 6A and 6B. Thus, the detection sensitivity of magneto-resistance effect element 1 is increased.

Magneto-resistance effect element 1 of the above embodiment which includes first and second bias magnetic layers 13, 17a, 17b will be referred to as Inventive Example, and the magneto-resistance effect element which has not second bias magnetic layers 17a, 17b according to the related art will be referred to as Comparative Example. The performances of the magneto-resistance effect elements according to Inventive Example and Comparative Example will be compared with each other. The layer structures of MR stack 2 and first and second bias magnetic layers 13, 17a, 17b according to the Inventive Example are identical to those of the above embodiment (see Tables 1, 2).

The layer structure of the MR stack according to the Comparative Example is identical to the layer structure of MR stack 2 according to the Inventive Example. The magneto-resistance effect element of the Comparative Example has an insulating film made of Al₂O₃ in place of second bias magnetic layers 17a, 17b. The magneto-resistance effect element of the Comparative Example also includes a CoPt film having a film thickness of 30 nm disposed as a first bias magnetic layer on an Al₂O₃ film having a film thickness of 5 nm and a Cr seed layer having a film thickness of 5 nm, on the side of the MR stack (or spin-valve film) which is opposite to the air bearing surface, as with the Inventive Example. In both the Inventive Example and Comparative Example, the width of the MR stack in track width direction T is 50 nm and the height of the MR stack is 50 nm.

Table 3 shows detection characteristics of the magneto-resistance effect elements according to the Inventive Example and Comparative Example. In Table 3, the effective track width is defined as a half-value width of a micro-track profile (an output profile produced by scanning a micro-track that is sufficiently narrower than the track width, in the track width direction).

TABLE 3

| | | | Optical | Effective |
|---|---|---|---|---|
| | Resistance | Output | Track | Track |
| | (Ω) | (mV) | Width (nm) | Width (nm) |
| Inventive Example | 20 | 1.2 | 50 | 50 |
| Comparative Example | 20 | 1.0 | 50 | 58 |

In the Inventive Example and Comparative Example, the magneto-resistance effect elements have a resistance of 20Ω and a magneto-resistance ratio of 5%. However, the signal output of the magneto-resistance effect element of the Inventive Example is higher than the signal output of the magneto-resistance effect element of the Comparative Example. This is because the perpendicularity of the magnetization directions of upper and lower magnetic layers 8, 6 in the initial magnetization state is improved. Consequently, the detection sensitivity of magneto-resistance effect element 1 of the Inventive Example is increased.

In the Inventive Example and Comparative Example, the optical track widths are the same as each other. However, the effective track width according to the Inventive Example is smaller than the effective track width according to the Comparative Example. This is because second bias magnetic layers 17a, 17b function as shields for shielding the magnetic fields emitted from adjacent tracks.

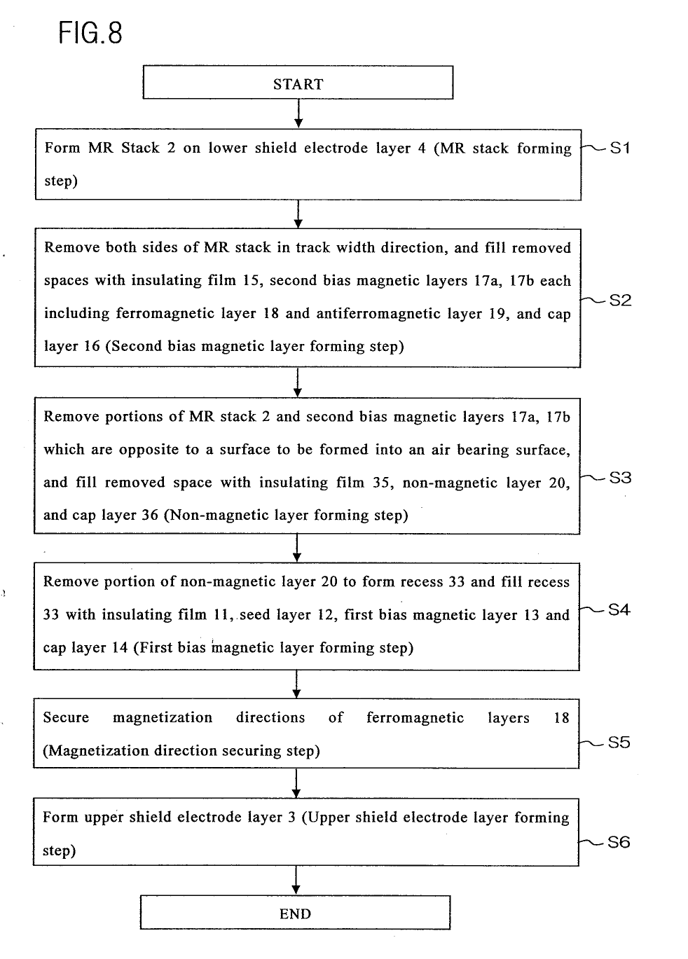

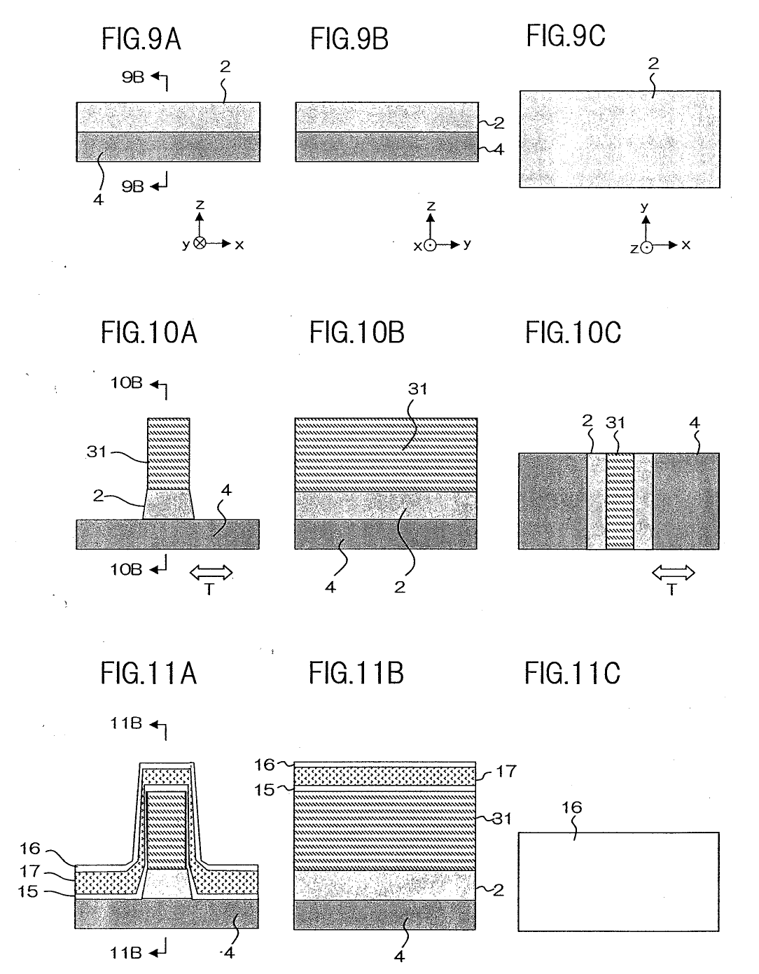

A method of manufacturing above-mentioned magneto-resistance effect element 1 will be described with reference to the flowchart of FIG. 8 and FIGS. 9A to 17C. FIGS. 9A, 10A, . . . , 17A are cross-section views of a wafer, taken along a surface forming a recording medium. FIGS. 9B, 10B, . . . , 17B are cross-section views of the wafer, cut out in a direction perpendicular to the surface forming the recording medium. FIGS. 9C, 10C, . . . , 17C are top views of the wafer. Positions of the cross-sections in FIGS. 9B, 10B, . . . , 17B are shown in FIGS. 9A, 10A, . . . , 17A, respectively.

(Step S1) First, lower shield electrode layer 4 is prepared by the plating process. Next, MR stack 2 is formed on lower shield electrode layer 4 by sputtering as shown in FIGS. 9A to 9C (MR stack forming step). As described above, MR stack 2 includes lower magnetic layer 6 whose magnetization direction changes in accordance with an external magnetic field, non-magnetic intermediate layer 7, and upper magnetic layer 8 whose magnetization direction changes in accordance with an external magnetic field. Lower magnetic layer 6, non-magnetic intermediate layer 7, and upper magnetic layer 8 are stacked successively upwardly in the order named. MR stack 2 also includes cap layer 9 which comprises a Ru layer and a Ta layer on upper magnetic layer 8.

(Step S2) Next, both sides of MR stack 2 in track width direction T are removed, and then the removed spaces are filled again with respective second bias magnetic layers 17a, 17b (second bias magnetic layer forming step). Specifically, as shown in FIGS. 10A to 10C, resist 31 is deposited on MR stack 2 and then formed into a predetermined shape. Using shaped resist 31 as a mask, the both sides of MR stack 2 in track width direction T are removed.

Thereafter, as shown in FIGS. 11A to 11C, insulating film 15 of Al₂O₃, magnetic layer 17 which is to become second bias magnetic layers, and cap layer 16 of Al₂O₃ are successively deposited on resist 31 and lower shield electrode layer 4. Magnetic layer 17 includes a ferromagnetic layer and an antiferromagnetic layer.

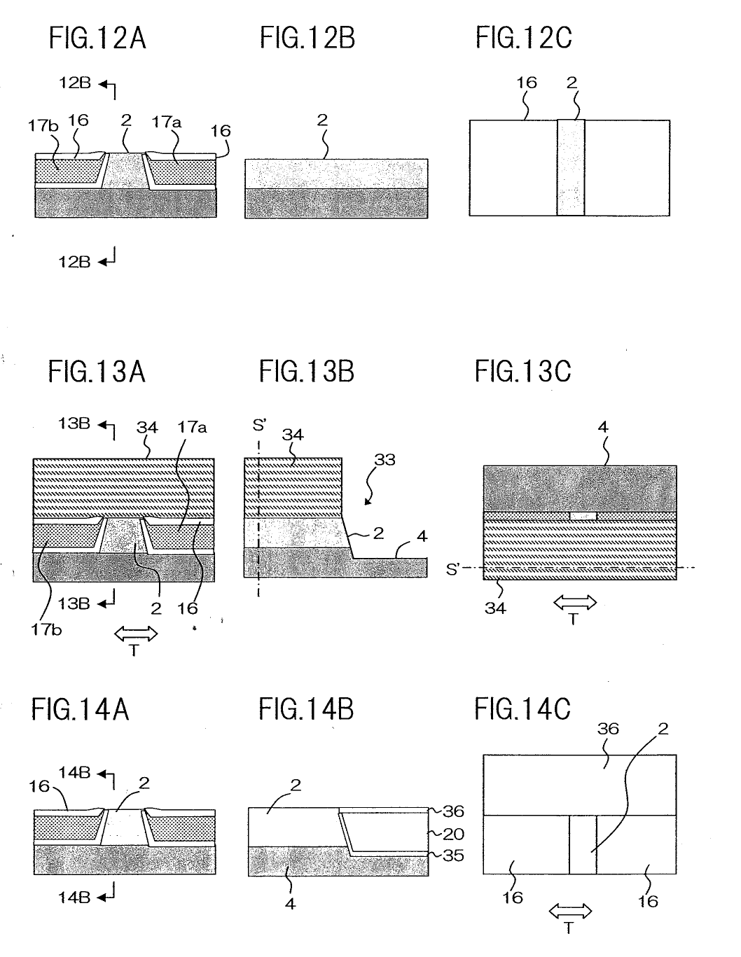

Further, as shown in FIGS. 12A to 12C, resist 31 is removed by the lift-off process together with insulating film 15, magnetic layer 17 and cap layer 16 which are deposited over resist 31. Magnetic layer 17 that is left on the both sides of MR stack 2 in track width direction T serves as second bias magnetic layers 17a, 17b.

Cap layer 16 should preferably be planarized to a level lying flush with the upper surface of MR stack 2. Cap layer 16 should be planarized for the purposes of planarizing upper shield layer 3 to be formed in a subsequent step and removing burrs formed when resist 31 and other layers are lifted off. Cap layer 16 may be planarized by chemical mechanical polishing (CMP), for example.

(Step S3) Next, portions of MR stack 2, cap layer 16, and second bias magnetic layers 17a, 17b on the side opposite to a plane S′ which is to become the air bearing surface are removed, and the removed space is filled with non-magnetic layer 20 (non-magnetic layer forming step). Specifically, as shown in FIGS. 13A to 13C, resist 34 is deposited on MR stack 2 and cap layer 16 and then formed into a predetermined shape. Using shaped resist 34 as a mask, the portions of MR stack 2, cap layer 16, and second bias magnetic layers 17a, 17b are removed.

Thereafter, as shown in FIGS. 14A to 14C, insulating film 35, non-magnetic layer 20 made of Cr, and cap layer 36 are successively deposited on resist 34 and lower shield electrode layer 4. Then, resist 34 is removed by the lift-off process. After the removal of resist 34, burrs are removed by CMP to provide a flat surface.

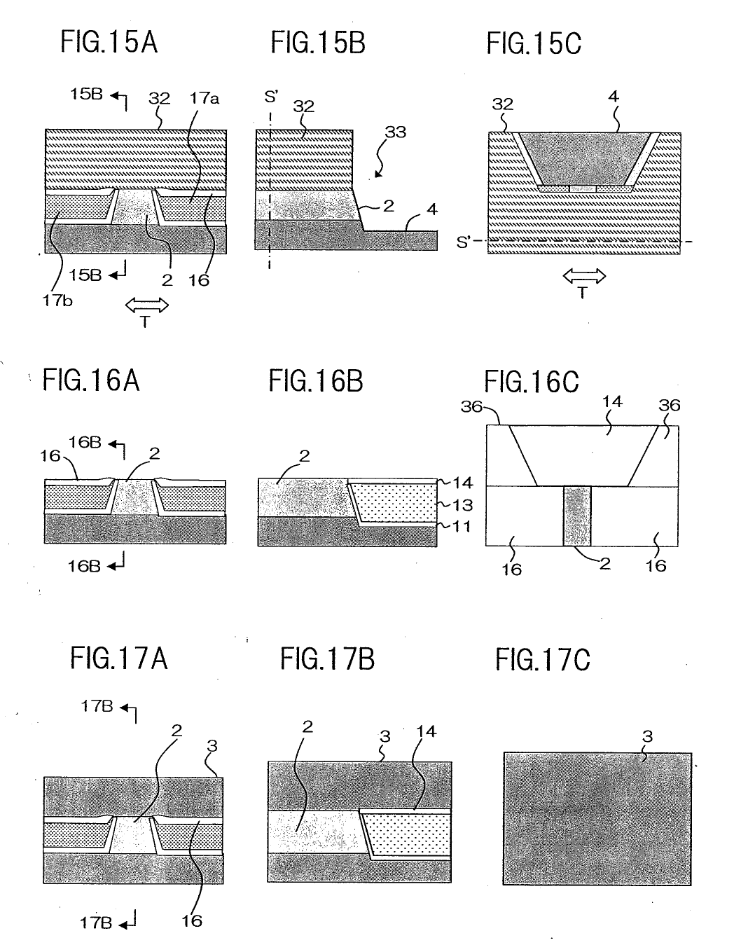

(Step S4) Next, portions of non-magnetic layer 20 and cap layer 36 are removed, and the removed space is filled with first bias magnetic layer 13 (first bias magnetic layer forming step). Specifically, as shown in FIGS. 15A to 15C, resist 32 is deposited on cap layer 36 and then formed into a predetermined shape. Using shaped resist 32 as a mask, the portions of non-magnetic layer 20 and cap layer 36 are removed, forming a recess 33.

Recess 33 extends toward MR stack 2 while a width thereof in track width direction T decreases. As shown in FIG. 15C, recess 33 is in the shape of an isosceles trapezoid as viewed from above. In the actual fabrication process, recess 33 does not need to be strictly in the shape of an isosceles trapezoid, but may be of a general trapezoidal shape or may have round corners. Since first bias magnetic layer 13 will be formed in recess 33 as described later, a portion of lower shield electrode 4 may be removed by means of milling if there is a need to ensure the thickness of first bias magnetic layer 13.

Thereafter, as shown in FIGS. 16A to 16C, insulating film 11, seed layer 12, first bias magnetic layer 13, and cap layer 14 are deposited in recess 33 (seed layer 12 is omitted from illustration). Insulating film 11 and seed layer 12 are formed by ion beam sputtering. In order to make insulating film 11 electrically insulative, insulating film 11 is held in reliable contact with the side wall of MR stack 2. Low-temperature CVD (chemical vapor deposition), rather than ion beam sputtering, may be employed to form insulating film 11 and seed layer 12.

Thereafter, resist 32 is removed by lift-off process. After the removal of resist 32, burrs are removed by CMP to provide a flat surface.

(Step S5) Then, the magnetization directions of ferromagnetic layers 18a, 18b of second bias magnetic layers 17a, 17b are secured (magnetization direction securing step). Specifically, the assembly is heated to a temperature equal to or higher than the blocking temperature of antiferromagnetic layers 19a, 19b, and then annealed. At this time, the magnetization directions of ferromagnetic layers 18a, 18b are secured by the magnetic field emitted from first bias magnetic layer 13. Since tip end width Wf of first bias magnetic layer 13 is small, the magnetic field emitted from first bias magnetic layer 13 lies substantially parallel to track width direction T within second bias magnetic layers 17a, 17b. Therefore, the magnetization directions of ferromagnetic layers 18a, 18b extend substantially parallel to track width direction T. The magnetization directions of ferromagnetic layers 18a, 18b of second bias magnetic layers 17a, 17b are substantially anti-parallel to each other. The magnetic pole on the surface of second bias magnetic layer 17a which faces MR stack 2 and the magnetic pole on the surface of second bias magnetic layer 17b which faces MR stack 2 are of the same polarity. The magnetic pole on the surface of first bias magnetic layer 13 which faces MR stack 2 and the magnetic poles on the surfaces of second bias magnetic layers 17a, 17b which face MR stack 2 are different from each other.

(Step S6) Next, as shown in FIGS. 17A to 17C, upper shield electrode layer 3 is formed on MR stack 2 and cap layers 14, 16, 36 (upper shield electrode layer forming step). Specifically, an electrode film (not shown) is formed to a film thickness of about 50 nm by sputtering, and then upper shield electrode layer 3 is formed on the electrode film by plating process.

Thereafter, a write head portion is formed, the wafer is then diced into bars, and the air bearing surface is formed by polishing. Further, each bar is separated into sliders, and the sliders are completed after undergoing processes, such as cleaning and inspections.

The effect which the shape of first bias magnetic layer 13 has on the signal output has been analyzed. MR stack 2 and second bias magnetic layers 17a, 17b of magneto-resistance effect element 1 that has been analyzed are of the layer structure shown in Tables 1, 2.

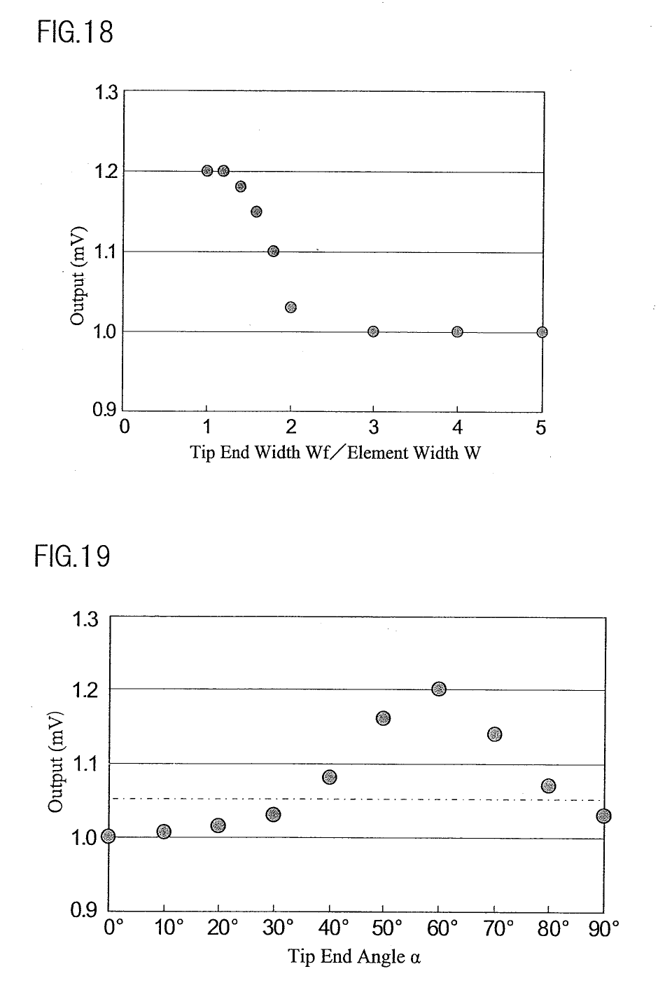

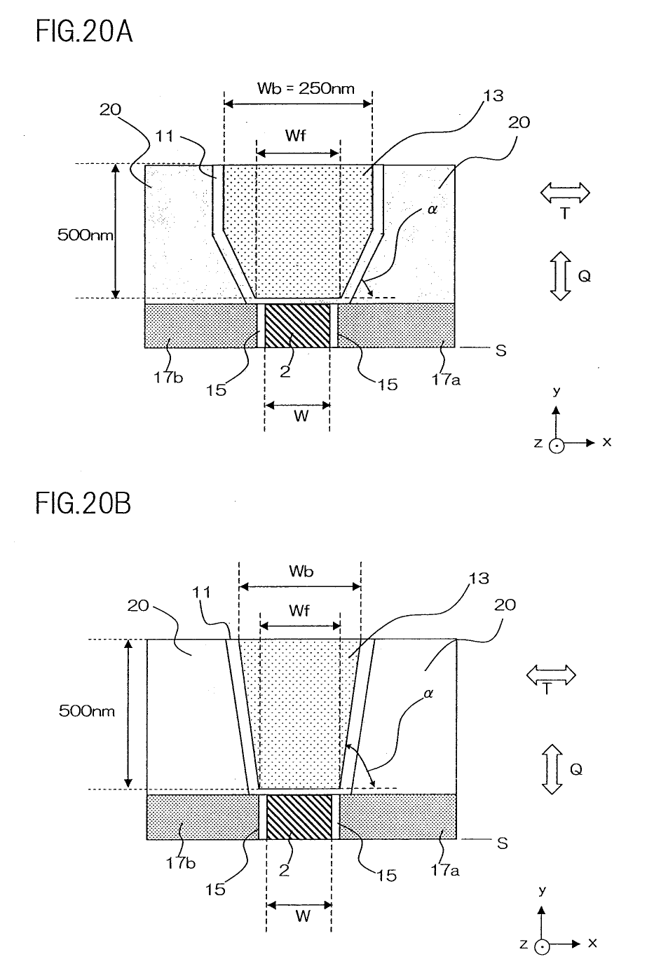

FIG. 18 is a graph showing the relationship between tip end width Wf of first bias magnetic 13 layer and the signal output of magneto-resistance effect element 1 at the time the magnetic field is detected. The horizontal axis of the graph represents values produced by dividing tip end width Wf of first bias magnetic 13 layer by the width (hereinafter referred to as element width W, see FIGS. 2A, 2C) of MR stack 2 in track width direction T. First bias magnetic layer 13 used for the measurement of the signal output has a hexagonal shape including an isosceles trapezoid as shown in FIG. 20A. First bias magnetic layer 13 has a width (hereinafter referred to as rear end width Wb) of 250 nm on its side opposite to air bearing surface S, and a tip end angle α of 60 degrees.

The signal output is of a substantially constant value of about 1.0 mV if tip end width Wf is in a range which is three times element width W or greater. The signal output increases as tip end width Wf decreases. The signal output sharply changes when tip end width Wf is about twice element width W. The signal output is maximum when tip end width Wf is essentially the same as element width W.

When tip end width Wf is large, the magnetic field emitted from first bias magnetic layer 13 is applied to second bias magnetic layers 17a, 17b in direction Q perpendicular to air bearing surface S. Therefore, the magnetization directions of second bias magnetic layers 17a, 17b are perpendicularly inclined to air bearing surface S, failing to apply a bias magnetic field in an appropriate direction to upper and lower magnetic layers 8, 6. For these reasons, the signal output is decreases when tip end width Wf is large.

Therefore, tip end width Wf should preferably be equal to or smaller than twice element width W, and more preferably be substantially equal to element width W.

FIG. 19 is a graph showing the relationship between tip end angle α of first bias magnetic layer 13 and the signal output of magneto-resistance effect element 1. FIGS. 20A, 20B show magneto-resistance effect element 1 used to measure the signal output shown in FIG. 19. Specifically, FIGS. 20A, 20B are cross-sectional views taken along a plane parallel to the film surface of MR stack 2, i.e., along the x-y plane in FIG. 1.

First bias magnetic layer 13 has a length of 500 nm in direction Q perpendicular to air bearing surface S, and has tip end width Wf having a thickness of 50 nm. If tip end angle α of first bias magnetic layer 13 is large, then first bias magnetic layer 13 is in the shape of an isosceles trapezoid as shown in FIG. 20B, and first bias magnetic layer 13 has tip end width Wf that has a thickness of 250 nm or less.

If tip end angle α of first bias magnetic layer 13 is small, then the width of first bias magnetic layer 13 is progressively larger away from MR stack 2 until the width reaches 250 nm (see FIG. 20A). In other words, first bias magnetic layer 13 has a hexagonal shape including an isosceles trapezoid.

If tip end angle α of first bias magnetic layer 13 is nil, then first bias magnetic layer 13 is in the shape of a rectangle having tip end width Wf that is 250 nm thick. If tip end angle α of first bias magnetic layer 13 is 90 degrees, then first bias magnetic layer 13 is in the shape of a rectangle having tip end width Wf that is 500 nm thick.

If tip end angle α of first bias magnetic layer 13 is nil, then magneto-resistance effect element 1 produces a signal output of about 1.0 mV. If tip end angle α is within a range from 0 degree to about 60 degrees, the signal output of magneto-resistance effect element 1 increases as tip end angle α increases. Then the signal output of magneto-resistance effect element 1 is maximum at tip end angle α that is about 60 degrees. If tip end angle α is within a range from about 60 degrees to 90 degrees, the signal output of magneto-resistance effect element 1 decreases as tip end angle α increases.

If tip end angle α is within a range from 40 degrees to 80 degrees, the signal output of magneto-resistance effect element 1 is at least 5% greater than if tip end angle α is nil. Therefore, tip end angle α should preferably be kept in the range from 40 degrees to 80 degrees, and more preferably be about 60 degrees.

The magneto-resistance effect element according to the present invention has been described in detail above. However, the present invention is not limited to the above embodiment and Inventive Example, but may be modified within the scope thereof. For example, second bias magnetic layers 17a, 17b may comprise respective antiferromagnetic layers 19a, 19b and respective ferromagnetic layers 18a, 18b disposed on respective antiferromagnetic layers 19a, 19b. The first bias magnetic layer does not need to be strictly trapezoidal in shape.

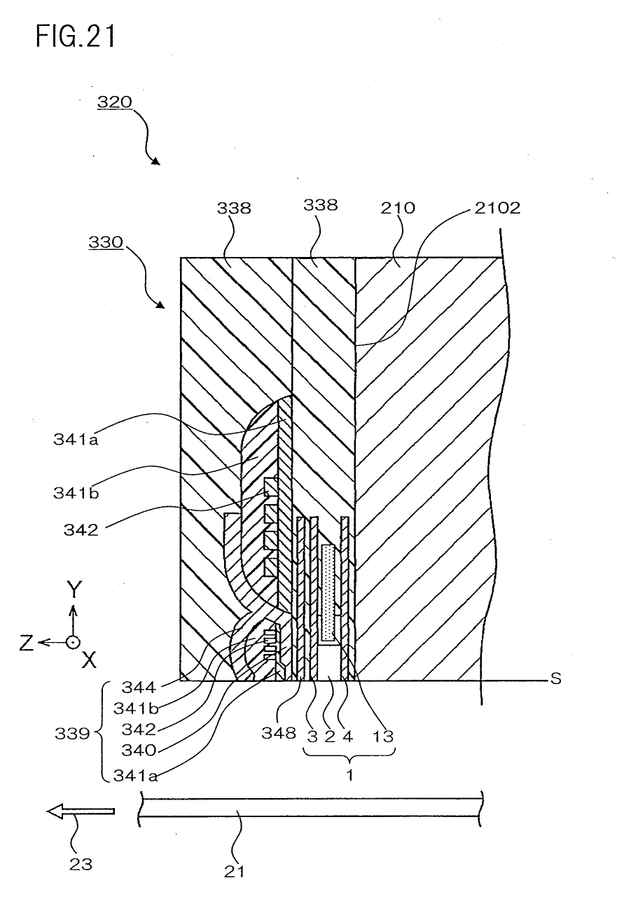

The following describes a thin film magnetic head in which the above-described magneto-resistance effect element has been used. FIG. 21 is a cross-sectional diagram through the thin film magnetic head in a direction perpendicular to air bearing surface S. As shown in FIG. 21, thin film magnetic head 320 includes slider 210 which is mainly composed of ALTIC (AL₂O₃—TiC), and magnetic head part 330. Magnetic head part 330 is provided on side surface 2102 of slider 210. Magnetic head part 330 includes magneto-resistance effect element 1 as a reproducing element and electromagnetic coil device 339 as an inductive-type electromagnetic conversion device.

The layers of MR stack 2 which forms magneto-resistance effect element 1 are provided to be substantially parallel to a side surface of slider 210, and lower shield electrode layer 4 is arranged to be closer to slider 210 than upper shield electrode layer 3. Upper and lower shield electrode layers 3 and 4 and MR stack 2 form a portion of air bearing surface S.

Device intermediate shield layer 348 composed of the same material as upper shield electrode layer 3 is formed between upper shield electrode layer 3 and electromagnetic coil device 339. Device intermediate shield layer 348 shields magneto-resistance effect element 1 from the magnetic field generated by electromagnetic coil device 339, and thereby reduces noise at readout. Further, a backing coil may be formed between device intermediate shield layer 348 and electromagnetic coil device 339. The backing coil generates magnetic flux which negates the magnetic flux loop via upper and lower shield electrode layers 3 and 4. As a result, it is possible to achieve suppression of the wide adjacent track erasure (WATE) phenomenon which entails unnecessary writing or deletion operations to recording medium 21.

Insulating layer 338 is formed between upper shield electrode layer 3 and device intermediate shield layer 348, between device intermediate shield layer 348 and electromagnetic coil device 339, and between lower shield electrode layer 4 and slider 210.

Electromagnetic coil device 339 is preferably a perpendicular magnetic recording-use coil. Electromagnetic coil device 339 includes main magnetic pole layer 340, gap layer 341a, coil insulating layer 341b, coil layer 342, and auxiliary magnetic pole layer 344. Main magnetic pole layer 340 leads magnetic flux induced by coil layer 342 to a recording layer of magnetic recording medium 21. Here, it is preferable that a width in the track—with direction (X-direction in the drawings) and a thickness in the layer direction (Z-direction in the drawings) of the end portion of main magnetic pole layer 340 on air bearing surface S side are smaller than at other portions of main magnetic pole layer 340. Such an arrangement allows generation of a fine ferromagnetic field for supporting a high recording density.

The end portion of auxiliary magnetic pole layer 344 on air bearing surface S side which is magnetically coupled to main magnetic pole layer 340 forms a trailing shield part having a cross-sectional surface which is wider than other portions of auxiliary magnetic pole layer 344. Auxiliary magnetic pole layer 344 faces the end portion of main magnetic pole layer 340 on air bearing surface S side via gap layer 341a and coil insulating layer 341b. Gap layer 341a and coil insulating layer 341b are formed using an insulator such as alumina. By providing auxiliary magnetic pole layer 344, the magnetic field gradient between auxiliary magnetic pole layer 344 and main magnetic pole layer 340 in the region of air bearing surface S is increased. As a result, jitter in the signal output is reduced, and the error rate during reading is reduced.

The thickness of auxiliary magnetic pole layer 344 is approximately 0.5 to 5 μm, and is constructed from an alloy composed of two or three materials selected from Ni, Fe, and Co, an alloy mainly composed of these materials with other elements added, or the like. Auxiliary magnetic pole layer 344 is formed using, for instance, a frame plating method or a sputtering method.

Gap layer 341a is formed between coil layer 342 and main magnetic pole layer 340, and is composed of Al₂O₃, DLC (Diamond-Like Carbon) or the like, at a thickness of 0.01 to approximately 0.5 μm. To form gap layer 341a, a sputtering method, a CVD method, or the like may be used.

Coil layer 342 is, for instance, formed from Cu or the like at a thickness of approximately 0.5 to approximately 3 μm. To form coil layer 342, a frame plating method or the like may be used. A rear end of main magnetic pole layer 340 is joined to a portion, of auxiliary magnetic pole layer 344, that is positioned away from air bearing surface S. Coil layer 342 is formed so as to surround this joint portion.

A coil insulating layer 341b composed of an insulator, such as a cured aluminum oxide or a resist layer, at a thickness of 0.1 to approximately 5 μm is formed between coil layer 342 and auxiliary magnetic pole layer 344. Insulating layer 338 is formed so as to cover electromagnetic coil device 339 on an opposite side of electromagnetic coil device 339 to the side of slider 210.

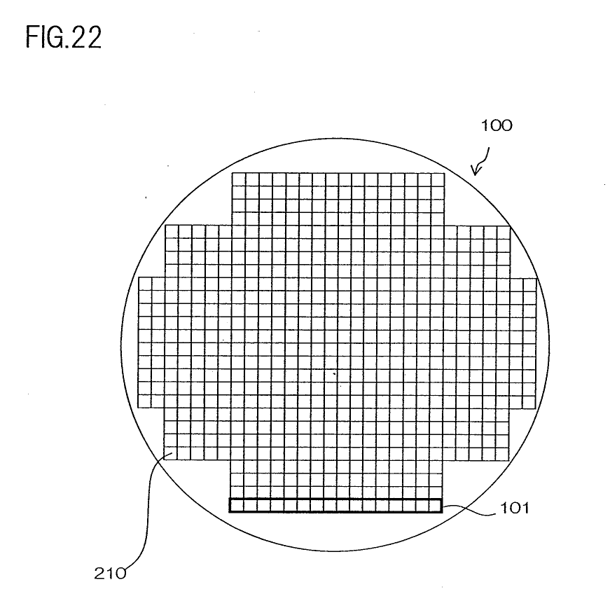

Next, explanation will be made regarding a wafer for fabricating a magnetic field detecting element described above. FIG. 22 is a schematic plan view of a wafer. Wafer 100 has a MR stack which is deposited thereon to form at least magneto-resistance effect element. Wafer 100 is diced into bars 101 which serve as working units in the process of forming air bearing surface ABS. After lapping, bar 101 is diced into sliders 210 which include thin-film magnetic heads. Dicing portions, not shown, are provided in wafer 100 in order to dice wafer 100 into bars 101 and into sliders 210.

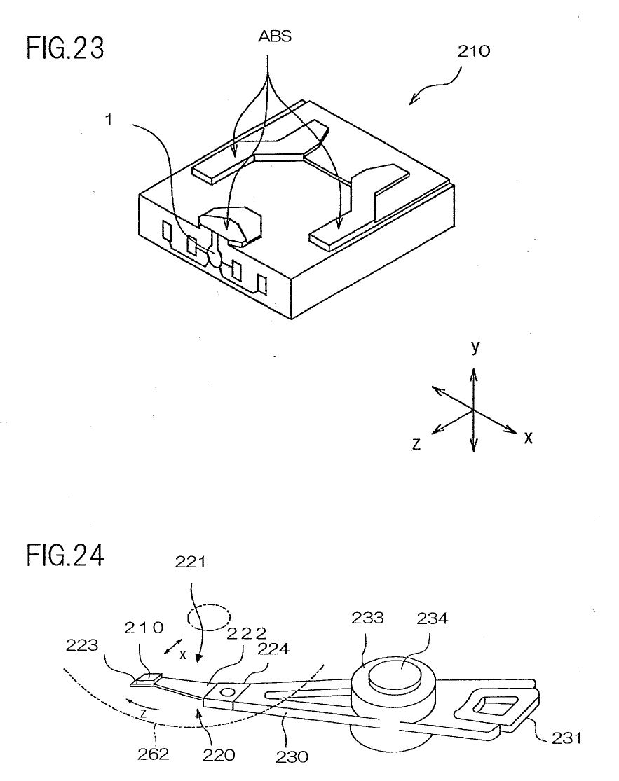

Referring to FIG. 23, slider 210 has a substantially hexahedral shape. One of the six surfaces of slider 210 forms an air bearing surface ABS, which is positioned opposite to the hard disk.

Referring to FIG. 24, head gimbal assembly 220 has slider 210 and suspension 221 for resiliently supporting slider 210. Suspension 221 has load beam 222 in the shape of a flat spring and made of, for example, stainless steel, flexure 223 that is attached to one end of load beam 222, and base plate 224 provided on the other end of load beam 222. Slider 210 is fixed to flexure 223 to provide slider 210 with an appropriate degree of freedom. The portion of flexure 223 to which slider 210 is attached has a gimbal section for maintaining slider 210 in a fixed orientation.

Slider 210 is arranged opposite to hard disk 262, which is a rotationally-driven disc-shaped storage medium, in a hard disk drive. When hard disk 262 rotates in the z direction shown in FIG. 24, airflow which passes between hard disk 262 and slider 210 creates a dynamic lift, which is applied to slider 210 downward in the y direction. Slider 210 is configured to lift up from the surface of hard disk 262 due to this dynamic lift effect. Magneto-resistance effect element 1 is formed in proximity to the trailing edge (the end portion at the lower left in FIG. 23) of slider 210, which is on the outlet side of the airflow.

The arrangement in which head gimbal assembly 220 is attached to arm 230 is called head arm assembly 221. Arm 230 moves slider 210 in transverse direction x with regard to the track of hard disk 262. One end of arm 230 is attached to base plate 224. Coil 231, which constitutes a part of a voice coil motor, is attached to the other end of arm 230. Bearing section 233 is provided in the intermediate portion of arm 230. Arm 230 is rotatably held by shaft 234 which is attached to bearing section 233. Arm 230 and the voice coil motor to drive arm 230 constitute an actuator.

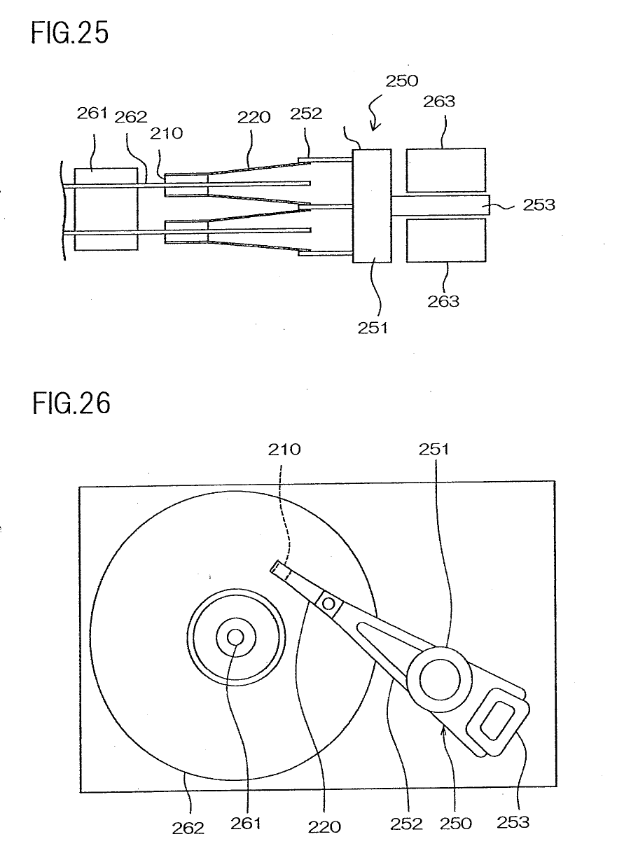

Referring to FIG. 25 and FIG. 26, a head stack assembly and a hard disk drive that incorporate the slider mentioned above will be explained next. The arrangement in which head gimbal assemblies 220 are attached to the respective arm of a carriage having a plurality of arms is called a head stack assembly. FIG. 25 is a side view of a head stack assembly, and FIG. 26 is a plan view of a hard disk drive. Head stack assembly 250 has carriage 251 provided with a plurality of arms 252. Head gimbal assemblies 220 are attached to arms 252 such that head gimbal assemblies 220 are arranged apart from each other in the vertical direction. Coil 253, which constitutes a part of the voice coil motor, is attached to carriage 251 on the side opposite to arms 252. The voice coil motor has permanent magnets 263 which are arranged in positions that are opposite to each other and interpose coil 253 therebetween.

Referring to FIG. 26, head stack assembly 250 is installed in a hard disk drive. The hard disk drive has a plurality of hard disks which are connected to spindle motor 261. Two sliders 210 are provided per each hard disk 262 at positions which are opposite to each other and interpose hard disk 262 therebetween. Head stack assembly 250 and the actuator, except for sliders 210, work as a positioning device in the present invention. They carry sliders 210 and work to position sliders 210 relative to hard disks 262. Sliders 210 are moved by the actuator in the transverse direction with regard to the tracks of hard disks 262, and positioned relative to hard disks 262. Magneto-resistance effect element 1 that is included in slider 210 writes information to hard disk 262 by means of the write head portion, and reads information recorded in hard disk 262 by means of the read head portion.

Although certain preferred embodiments of the present invention have been shown and described in detail, it should be understood that various changes and modifications may be made without departing from the spirit or scope of the appended claims.

1. A magneto-resistance effect element comprising:
a magneto-resistance effect stack including an upper magnetic layer and a lower magnetic layer whose magnetization directions change in accordance with an external magnetic field, a non-magnetic intermediate layer sandwiched between the upper and lower magnetic layers;
an upper shield electrode layer and a lower shield electrode layer which are provided to sandwich the magneto-resistance effect stack therebetween in the direction of stacking the magneto-resistance effect stack, wherein the upper shield electrode layer and the lower shield electrode layer supply sense current in the direction of stacking, and magnetically shield the magneto-resistance effect stack;
a first bias magnetic layer which is provided on a surface of the magneto-resistance effect stack opposite to an air bearing surface, and wherein the first bias magnetic layer is magnetized in a direction perpendicular to said air bearing surface; and
a pair of second bias magnetic layers provided on respective both sides of said magneto-resistance effect stack in a track width direction, and wherein the second bias magnetic layers are magnetized in a direction substantially parallel to said track width direction;
wherein the magnetic pole on a surface of one of said second bias magnetic layers which faces said magneto-resistance effect stack has the same polarity as the magnetic pole on a surface of the other of said second bias magnetic layers which faces said magneto-resistance effect stack, and has a polarity different from the polarity of the magnetic pole on a surface of said first bias magnetic layer which faces said magneto-resistance effect stack.

2. The magneto-resistance effect element according to claim 1, wherein each of said second bias magnetic layers comprises:
a ferromagnetic layer; and
an antiferromagnetic layer exchange-coupled to said ferromagnetic layer.

3. The magneto-resistance effect element according to claim 1, wherein each of said second bias magnetic layers comprises a soft magnetic layer.

4. The magneto-resistance effect element according to claim 1, wherein said first bias magnetic layer extends toward said magneto-resistance effect stack while a width thereof in the track width direction decreases.

5. The magneto-resistance effect element according to claim 1, wherein said first bias magnetic layer is shaped as a substantially isosceles trapezoid within a stacked plane of said magneto-resistance effect stack;
said isosceles trapezoid has two parallel sides, one of which is shorter than the other and the shorter side is disposed to be closer to said magneto-resistance effect stack.

6. The magneto-resistance effect element according to claim 1, wherein said first bias magnetic layer is shaped as a substantially isosceles trapezoid within a stacked plane of said magneto-resistance effect stack;
said isosceles trapezoid has two parallel sides, one of which is shorter than the other and the shorter side is disposed to be closer to said magneto-resistance effect stack; and
said shorter side has a width which is twice the width of said magneto-resistance effect stack in the track width direction or less.

7. The magneto-resistance effect element according to claim 1, wherein said first bias magnetic layer is shaped as a substantially isosceles trapezoid within a stacked plane of said magneto-resistance effect stack;
said isosceles trapezoid has two parallel sides, one of which is shorter than the other and the shorter side is disposed to be closer to said magneto-resistance effect stack; and
said shorter side has a width which is substantially equal to the width of said magneto-resistance effect stack in the track width direction or less.

8. The magneto-resistance effect element according to claim 1, wherein said first bias magnetic layer is shaped as a substantially isosceles trapezoid within a stacked plane of said magneto-resistance effect stack;
said isosceles trapezoid has two parallel sides, one of which is shorter than the other and the shorter side is disposed to be closer to said magneto-resistance effect stack; and
said isosceles trapezoid has an exterior angle in a range from 40 degrees to 80 degrees at both ends of the shorter side.

9. The magneto-resistance effect element according to claim 1, wherein said first bias magnetic layer is shaped as a substantially isosceles trapezoid within a stacked plane of said magneto-resistance effect stack;
said isosceles trapezoid has two parallel sides, one of which is shorter than the other and the shorter side is disposed to be closer to said magneto-resistance effect stack; and
said isosceles trapezoid has an exterior angle of about 60 degrees at both ends of the shorter side.

10. The magneto-resistance effect element according to claim 1, wherein said non-magnetic intermediate layer is made of copper and has a film thickness of about 1.3 nm.

11. The magneto-resistance effect element according to claim 1, further comprising:
an insulating film disposed between said magneto-resistance effect stack and said first bias magnetic layer, and between said magneto-resistance effect stack and second bias magnetic layers.

12. The magneto-resistance effect element according to claim 1, further comprising:
non-magnetic layers disposed on the both sides of said first bias magnetic layer in the track width direction.

13. A slider including the magneto-resistance effect element according to claim 1.

14. A wafer having a magneto-resistance effect stack that is to be formed into the magneto-resistance effect element according to claim 1.

15. A head gimbal assembly including the slider according to claim 13, and a suspension for resiliently supporting the slider.

16. A hard disk drive including the slider according to claim 13, and a device for supporting the slider and positioning the slider with respect to a recording medium.

17. A method of manufacturing a magneto-resistance effect element, comprising:
a magneto-resistance effect stack forming step of forming a lower magnetic layer whose magnetization direction changes in accordance with an external magnetic field, a non-magnetic intermediate layer, and an upper magnetic layer whose magnetization direction changes in accordance with an external magnetic field, successively upwardly in the order named in a direction of stacking, on a lower shield electrode layer;
a second bias magnetic layer forming step of removing both sides of said magneto-resistance effect stack in a track width direction, and filling removed spaces with a pair of second bias magnetic layers respectively therein;
a first bias magnetic layer forming step of forming a recess in a surface opposite to a surface to be formed into an air bearing surface of said magneto-resistance effect stack, wherein said recess extends toward said magneto-resistance effect stack while a width thereof in the track width direction decreases, and filling a portion of said recess with a first bias magnetic layer;
a magnetization direction securing step of securing magnetization directions of said second bias magnetic layers substantially parallel to said track width direction, such that the magnetic pole on a surface of one of said second bias magnetic layers which faces said magneto-resistance effect stack has the same polarity as the magnetic pole on a surface of the other of said second bias magnetic layers which faces said magneto-resistance effect stack, and has a polarity different from the polarity of the magnetic pole on a surface of said first bias magnetic layer which faces said magneto-resistance effect stack; and
an upper shield electrode layer forming step of forming an upper shield electrode layer on said magneto-resistance effect stack, said first bias magnetic layer, and said second bias magnetic layers.

18. The method of manufacturing a magneto-resistance effect element according to claim 17, further comprising:
a non-magnetic layer forming step of removing respective both sides of a region to be formed into said first bias magnetic layer in a track width direction, and filling removed spaces with a non-magnetic layer.

19. The method of manufacturing a magneto-resistance effect element according to claim 17, wherein each of said first bias magnetic layers comprises:
a ferromagnetic layer; and
an antiferromagnetic layer exchange-coupled to said ferromagnetic layer; and
wherein said magnetization direction securing step comprises the step of, after said first bias magnetic layer forming step, annealing said MR stack to a temperature equal to or higher than a blocking temperature of said antiferromagnetic layer, within a magnetic field emitted from said first bias magnetic layer.
